(19) United States
(12) Patent Application Publication
(10) Pub. No.: US 2002/0119823 A1
(43) Pub. Date: Aug. 29, 2002

(54) Method and apparatus for interactive audience participation in a live event

(76) Inventor: Jarrell A. Beuscher, Shawnee, KS (US)

Correspondence Address: Intellectual Property Dept., SPENCER FANE BRITT & BROWNE LLP, Suite 1400, 1000 Walnut Street, Kansas City, MO, 64106-2140, US

(21) Appl. No.: 09/796,311

(22) Filed: Feb. 28, 2001

(51) Int. Cl. G06F 17/00

(52) U.S. Cl. 463/42

(57) ABSTRACT

A method of, and apparatus for, permitting a member of an audience of a controllable, real-life event, such as a football game, to participate in determining the outcome of the event is provided. An audience member/participant can access a central controller using a remote user interface such as a computer terminal. The audience participant is allowed to select a desired course of action for the event. In the context of a football game, the audience participant selects the play to be performed by the football team. The selected play is transmitted to the central controller over a communications network such as the internet. The play selected by a majority of audience participants is determined by the central controller. The coach of the football team accesses the central controller to obtain the majority-selected play, and then relays this play to the football team who performs the play in the game. In one embodiment of the present invention, the coach accesses a central controller using a Personal Digital Assistant having wireless internet capabilities.

### FIELD OF THE INVENTION

The present invention relates to an apparatus for and a method of providing realtime interactive audience control over a real-life event such as a football game. The invention permits audience members to participate, from a remote location, in the decision making process of an event such as the play selection in a football game. The audience members' decisions ultimately contribute to the outcome of the event.

### BACKGROUND OF THE INVENTION

Video games allowing player participants to interactively control the action and outcome of a simulated event are well known. For example, U.S. Pat. No. 5,695,401 issued Dec. 9, 1997 to Lowe et al., describes and illustrates a video game which provides a player with interactive control over a “live action” football game. This game comprises a plurality of individual, pre-recorded football plays illustrating interaction of “live” (not simulated) players of opposite teams. The game allows a single participant to select from a group of plays; the selected pre-recorded play is then displayed to the participant. The primary disadvantage of Lowe et al. is that it does not allow participants to contribute to the outcome of a real-life event as that event is occurring.

Several games have been developed that allow participant control over a real-life event. For example, U.S. Pat. No. 5,993,314 issued Nov. 30, 1999 to Dannenberg et al., discloses an interactive audience participation system which utilizes audio command signals such as loudness or sound intensity from competing audience groups to manipulate the position of an object. An example of the game of the Dannenberg et al. invention would be in the form of a motorized vehicle whose direction is controlled by audio signals of audience groups present at a sporting event. For example, the audience of a football game could be divided into two separated groups, such as one group in each end zone. Microphones are positioned to detect audio inputs from each of the separated groups. The motorized vehicle can then be competitively moved towards the opposite end zones by the audio inputs of each respective group. In practice, the group who is able to shout the loudest would represent the end zone towards which the motorized vehicle would be directed. The Dannenberg et al. invention has several disadvantages including the fact that it does not disclose a method of allowing multiple participants to independently select a desired course of action for an event. In fact no selection is made by the audience groups of Dannenberg et al.; whose audience groups merely exert sufficient force to achieve a single predetermined action. Additionally, Dannenberg et al. does not disclose a method of permitting remote participation.

The advent of the Internet as a global communications network has vastly expanded the boundaries of traditional games to allow participation from remote locations. Many video games, such as that disclosed by U.S. Pat. No. 5,083,800 issued to Lockton, provide for multiple players, located remotely from each other, to participate in realtime action simulations. Other games, such as the video game of U.S. Pat. No. 5,964,660 issued to James et al., further provide for interactive competition among remote participants. A significant disadvantage of the inventions of Lockton and James et al. is that they only apply to simulations; they do not provide for participation in a real-life event.

Many inventions have been developed that provide for interactive participation in games that are based on a real-life event. For example, U.S. Pat. No. 5,860,862 issued to Junkin discloses a “fantasy football” game. Participants of the “fantasy football” game of Junkin select players from a real-life football game and then receive a score based upon each selected player's performance. To enhance the enjoyment, and to increase participant control over the “fantasy football” game, participants are permitted to modify their player selections throughout the course of the real-life football game. Although this invention does give participants increased control over the “fantasy football” game, it does not give a participant any control over the outcome of a real-life event.

Similar to the “fantasy football” game of Junkin, U.S. Pat. No. 6,080,063 issued to Khosla discloses a simulated, real-time game which is played in conjunction with a real-life event. The embodiment of Khosla's disclosure is that of an automobile race. A real-life race having real cars and real racers is performed and broadcast as a video game to the remote participants. The remote participants are allowed to participate in the race as simulated automobiles. The remote participants have no control over the actual outcome of the event, they are merely allowed to simulate their realtime participation in the real-life event.

Until the development of the invention disclosed herein, inventions that provide for realtime remote participation in and control over a real-life event have been limited to only allow the direct control by a single participant. For example, the invention of Takemoto et al. discloses a game, such as a pinball machine, which can be played by a single participant from a remote location. The disclosure of Takemoto et al. lacks the ability to allow multiple participants to collectively contribute to the outcome of a single event.

### SUMMARY OF THE INVENTION

A principal object of the present invention is to provide realtime audience control over the progression of a real-life event such as a football game.

In order to achieve the above-described objective, one aspect of the present invention is directed to a method of interactive audience participation in an event. In the method of the present invention, an audience will view a controllable, real-life event, such as a football game. As the event is taking place, each audience participant will be allowed to individually select a desired course of action for the event. The desired course of action for each audience participant will be collected to determine a course of action selected by a majority of the audience participants. This audience majority, selected course of action will then be performed in the event.

In one embodiment of the present invention, the controllable event comprises an interactive sports franchise, such as a football team, that allows audience members to participate in coaching decisions. In the context of a football game, there are virtually countless decisions which must be made by the coach of a football team. These decisions ultimately contribute to the outcome of the game. For example, the coach makes such determinations as who will play, what play will be run on the field, when to call a timeout and when to request an instant replay review. It is an object of the present invention to enable audience members of a football game to actively participate in a team's coaching decisions during the game without departing from the normal time constraints of a football game. In one embodiment of the present invention audience participants and a football team's sideline coach will communicate via a global communications network such as the internet. During the course of a football game, each audience participant, accessing a remote user interface, will select a desired play and transmit their selection to a central controller over the communications network. The play selected by a majority of the audience participants will be determined by the central controller which is accessible by the sideline coach. The sideline coach will then inform the football team to perform the play selected by the audience majority.

To meet the time constraints of a standard football game, the sideline coach may select a play from an electronic play book stored in memory of the central controller. The central controller will then randomly generate alternative play options (coaching decision options) using the formation of the play selected by the sideline coach. The total number of alternative play options can be limited to meet time constraints; for example the central controller might randomly generate a total of twelve options, including perhaps six running and six passing plays. The play options, and the play selected by the sideline coach, will be transmitted to each participant and displayed via the remote user interface. The participant will have approximately fifteen to twenty seconds to select from one of the random play options, or to select the play option chosen by the sideline coach. Once a participant, using the remote user interface, selects a play, that play will be transmitted back to the central controller where the majority-selected play is determined. If a participant fails to select a play within the required time period, that participant's selection will not be counted to determine the majority-selected play.

One embodiment of the central controller of the present invention comprises a Personal Digital Assistant (PDA) that is connected to the internet via a wireless connection. The PDA may include memory for storing the electronic play book, and a processor for randomly generating play options and for determining the majority-selected play. Alternatively, the memory and processor may be located remote from the PDA. In such an embodiment, the PDA would simply provide a connection to access the processor and the memory. A more traditional embodiment of the central controller might comprise a sideline coach in communication with a press-box coach over a standard headset, the press-box coach would access the communications network via a computer terminal and relay the majority-selected play to the sideline coach via the headset.

The remote user interface of the present invention can include a streaming video feed, a data screen, a statistics screen, a chat window, an advertisement screen and play option links. The streaming video feed will provide a live broadcast of the football game, permitting a participant to watch the game and participate in coaching the game from any location having access to the internet. The data screen includes current game information such as a running play clock, down, and field position. The statistics screen displays game statistics such as personal statistics for each football player and personal statistics for each interactive participant. Examples of statistics for a football player include completion percentages and yards per carry. Interactive participant statistics can include ratings based on play selection. The chat window allows participants to communicate with each other during the came to compare game strategies. An advertising screen assists football teams in realizing profits from the interactive audience participation by allowing advertisers to market goods and services to participants. The play option links display diagrams of the play options; they can be active links to provide for simple play selection.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a diagram showing the functional layout of the present invention.

FIG. 2 is a diagram showing an embodiment of a remote user interface for the present invention.

### DESCRIPTION OF THE PREFERRED EMBODIMENT

Preferred embodiments of the present invention are hereinafter described with reference to the accompanying drawings.

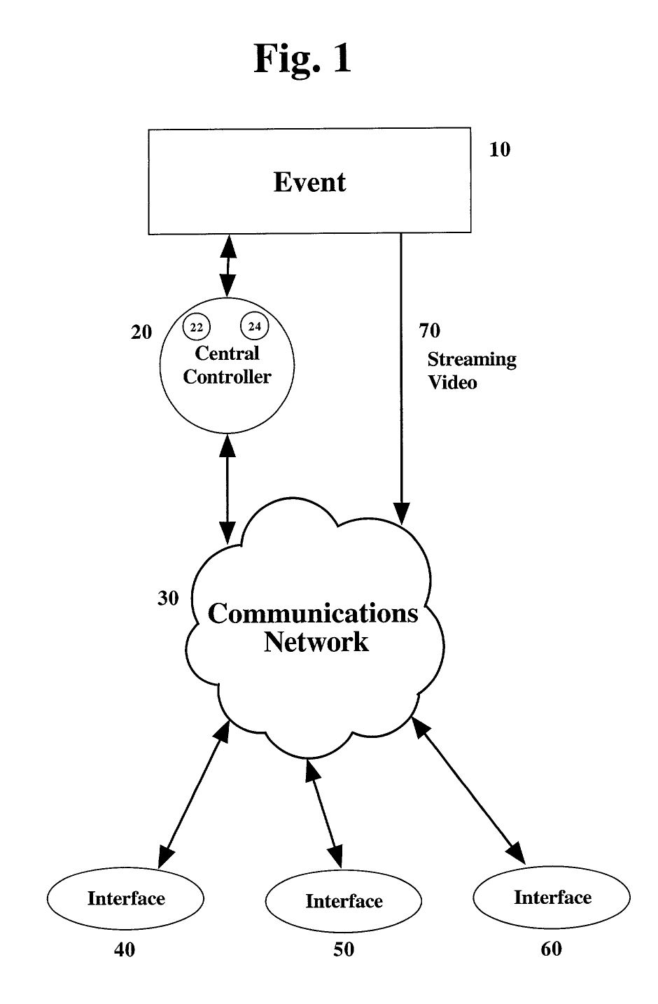

Referring to FIG. 1, a functional layout of the invention is presented. In general the scheme utilized in the inventive method comprises interactive audience participants accessing remote user interfaces 40, 50 and 60 selecting a desired course of action for controllable event 10, transmitting said desired course of action via communications network 30 to central controller 20, determining a majority-selected course of action at central controller 20, and performing said majority-selected course of action in controllable event 10.

A preferred embodiment of the present invention is one in which controllable event 10 is a football game. The interactive audience participants are a football fans who desire to participate in the coaching decisions for the football team. The audience participants may be members of a live audience in attendance at the football game, or they may be observing the game via a live broadcast. The live broadcast may be accomplished through traditional media such as radio or television. Alternatively, the live broadcast may be accomplished via streaming video 70 over communications network 30.

Remote user interfaces 40, 50 and 60 for audience participants that are in attendance at a football game can be connected to central controller 20 through a variety of communications networks such as hard-wire or radio-signal type communications. A preferred embodiment for communications network 30 would be a global communications network, such as the internet. A preferred embodiment for remote user interfaces 40, 50 and 60 would be a Personal Digital Assistant (PDA) having wireless internet capabilities. Such an embodiment is preferable for use by participants attending a game due to the fact that a PDA is portable, it does not require significant remodeling of existing stadiums (as is necessary for hard-wire communication systems), and it does not require substantial investments in specialized radio equipment.

When audience participants are not in attendance at the football game, a localized communications network, such as hard-wire or radio-signal is even less practical than it would be for attending participants. However, the advantages of the portability of a PDA is less noticeable. In fact, the wireless connection of a PDA may be disadvantageous in that it could restrict the features available on remote user interfaces 40, 50 and 60. For example, streaming video 70 may be impractical via a wireless connection. Therefore, a preferred embodiment for communications network 30 is a global communications network such as the internet, and a preferred embodiment for remote user interfaces 40, 50 and 60 is a computer terminal having a traditional (modem or high speed type) connection to the internet.

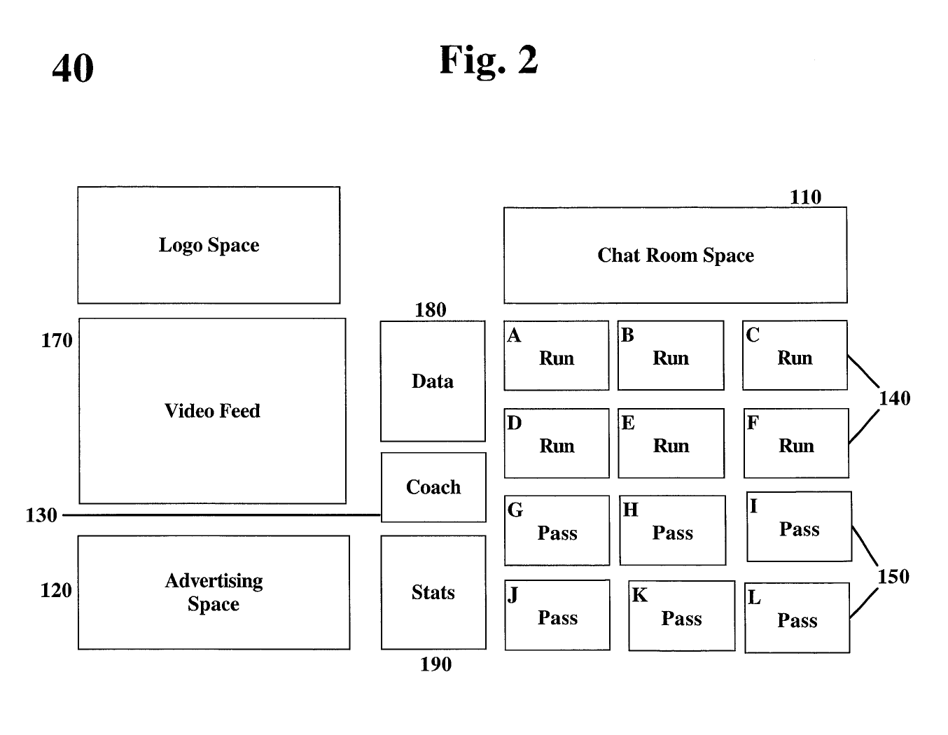

FIG. 2 shows a block diagram of one embodiment of remote user interface 40 to be used by a participant in connection with the present invention. In this embodiment, controllable event 10 is broadcast to participants over communications network 30 via streaming video 70. Controllable event 10 is displayed to each participant through video feed 170. Communication between participants can be provided over communications network 30 and displayed to each participant through chat window 110. Advertisements generated from central controller 20 can be displayed to participants through advertisement screen 120. Data screen 180 displays data relating to the progress of controllable event 10. Statistics screen 190 displays statistical information relating to the performance of real-life players and interactive participants. Outcome option links 130, 140 and 150 allow participants to select a desired course of action for controllable event 10.

To provide a better understanding of the present invention, its operation will now be discussed regarding a non-attending participant of a football game. An interactive participant will access central controller 20 through a computer terminal (remote user interface 40) using the internet as communications network 30. The football game will be broadcast to the computer terminal's video feed 170 via streaming video 70. During the course of the game, a sideline coach will access central controller 20 through the use of a PDA. Central controller 20 includes memory 22 for storing an electronic play book of the sideline coach. The sideline coach will select a play from the electronic play book. The coach's play will be transmitted from central controller 20 to remote user interface 40 over the internet. This play will be displayed to the participant as a play diagram in play option link 130. Additionally, processor 24 of central controller 20 will randomly select six running plays (plays A through F) and six passing plays (plays G through L) using the formation of the coach's play. These random plays will be displayed as play diagrams to the participant in play option links 140 (run plays) and 150 (pass plays). The participant will have approximately fifteen to twenty seconds to either select one of the twelve randomly generated play options, or else select the coach's play option. Play option links 130, 140 and 150 are active links, thus the participant merely has to click on the desired play option with a computer mouse to make a selection.

Once a play is selected by the participant, that selection will be transmitted to central controller 20 over the internet. Central controller 20 will receive play selections from all participants and use processor 24 to determine which play option has been selected by a majority of the participants. The majority-selected play will then be transmitted to the PDA held by the sideline coach. The coach will then relay the play to the team to be performed in the game (controllable event 10).

In addition to deciding what play to run during a football game, interactive participant control can be increase by allowing participants to make other important coaching decisions such as player roster, timeout decisions, instant replay requests, or even coach replacement.

Central controller 20 may also be used to record participant statistics, such as successful play selection. For example, each participant can be given a Quickest Chosen Play (QCP) rating, which is based upon the participant's speed in selecting a play and their proficiency in selecting the play that is chosen by a majority of the participants. Participants can compete with each other to achieve the highest QCP rating. The participant having the highest QCP rating can win prizes provided by the operators of the interactive football team.

Since football is usually watched by groups of people at a single location, another aspect of the invention would enable multiple participants to make individual play selections from a single remote user interface.

While three remote user interfaces 40, 50 and 60 have been shown and described, it is understood that any number of user interfaces can be used with the above-described invention, depending only upon the limits of central controller 20 and the total number of participants.

Though the preferred embodiment of central controller 20 has been described as a computer, it is understood that central controller 20 is not limited to such an apparatus. For example, where communications network 30 is a radio-signal type network, central controller 20 could simply comprise a coach that listens to a headset and mentally determines the majority-selected play. Additionally, user interfaces 40, 50 and 60 are not limited to computer terminals and PDA's; instead, user interfaces 40, 50 and 60 are understood to comprise any apparatus practicable for the employed communications network.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described. A preferred embodiment of the present invention has been described in the context of a football game; however, the present invention may be applied to any sporting event, or any other type of real-life event where spectator control is desirable.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method and apparatus for audience participation is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall there between.

Having thus described the invention what is claimed as new and desired to be secured by Letters Patent is as follows:

1. A method of interactive audience participation in a real-life controllable event, the method comprising the steps of:
allowing at least one audience participant to select a desired course of action for a controllable event;
determining an audience majority-selected course of action; and
performing said audience majority-selected course of action in said controllable event.

2. The method as claimed in claim 1 wherein said audience participant is a non-attending participant.

3. The method as claimed in claim 1 further comprising the step of broadcasting said controllable event over a communications network to said audience participant.

4. The method as claimed in claim 1 further comprising the step of transmitting decision options to said audience participant.

5. The method as claimed in claim 1 further comprising the step of providing an on-screen chat feature.

6. The method as claimed in claim 1 further comprising the step of calculating a quickest chosen play rating for said audience participant.

7. The method as claimed in claim 1 further comprising the step of displaying marketing information to said audience participant.

8. The method as claimed in claim 1 wherein multiple audience participants are located at a single location, and each of said multiple audience participants is permitted to select an independent desired course of action for said controllable event.

9. A method of interactive audience participation in a real-life football game, the method comprising the steps of:
broadcasting a football game over a global communications network to the audience;
transmitting a plurality of coaching decision options for said football game over said global communications network;
allowing at least one audience participant to select a desired course of action from said plurality of coaching decision options;
receiving said desired course of action at a central location via said global communications network;
determining an audience majority-selected course of action based upon said received desired course of action; and
performing said audience majority-selected course of action in said football game.

10. The method as claimed in claim 9 wherein said plurality of coaching decision options are selected from the group consisting of play selection, player lineups, instant replay decisions, timeouts, and coaching personnel.

11. An apparatus for interactive audience participation in a real-life controllable event, comprising:
a central controller comprising a processor for determining a majority-selected course of action for the controllable event;
a remote user interface for allowing an interactive participant to select a desired course of action for a controllable event; and
a communications network for connecting said central controller to said user interface.

12. The apparatus as claimed in claim 11 wherein said central controller further comprises a memory for storing an electronic play book for said controllable event.

13. The apparatus as claimed in claim 11 wherein said processor generates random decision options.

14. The apparatus as claimed in claim 11 wherein said central controller comprises a Personal Digital Assistant.

15. The apparatus as claimed in claim 11 further comprising a Personal Digital Assistant connectable to said central controller.

16. The apparatus as claimed in claim 11 further comprising a streaming video connectable to said remote user interface over said communications network.

17. The apparatus as claimed in claim 11 wherein said remote user interface further comprises a streaming video feed.

18. The apparatus as claimed in claim 11 wherein said remote user interface comprises play option links.

19. The apparatus as claimed in claim 11 wherein said remote user interface comprises a display selected from the group consisting of logos, advertisements, data and statistics.

20. The apparatus as claimed in claim 11 wherein said remote user interface comprises a chat room feature.
